(19) United States
(12) Patent Application Publication
(10) Pub. No.: US 2002/0025033 A1
(43) Pub. Date: Feb. 28, 2002

(54) Protective phone cover

(76) Inventor: Sharon Vernon, Laguna Niguel, CA (US)

Correspondence Address: Matthew J. Peirce, Esq., 1550 Starlight Canyon Avenue, Las Vegas, NV, 89123, US

(21) Appl. No.: 09/938,918

(22) Filed: Aug. 25, 2001

Related U.S. Application Data
(60) Provisional application No. 60/228,313, filed on Aug. 28, 2000.

(51) Int. Cl. H04M 1/00

(52) U.S. Cl. 379/451

(57) ABSTRACT

A new and improved apparatus is disclosed to cover up a headset of a public phone. The present invention would be fabricated from plastic and would have a small tear-away portion at one end, which would allow the device to be placed over a standard phone. Removal of the tear-away portion would allow a portion of the present invention located over the mouthpiece of the headset to be exposed, but this is likely to be a less offensive part of a public telephone that a user would have to deal with compared to other portions which would be handled more frequently. Once the tear-away portion is removed and the present invention is installed on a standard telephone line, the tear-away portion can be used as a finger cap to dial on the touch tone pad on a telephone associated with the headset of the present invention.

### BACKGROUND OF THE INVENTION

The present invention concerns that of a new and improved apparatus to cover up a headset of a public phone.

### DESCRIPTION OF THE PRIOR ART

U.S. Pat. No. D371,136, issued to Horowitz, discloses an ornamental design for a sanitary cover for telephones.

U.S. Pat. No. 3,589,106, issued to Onuki, discloses a filter for sterilizing the air at site of a telephone mouthpiece, a speaking window and an air outlet of an air-conditioning system.

U.S. Pat. No. 2,607,862, issued to Panken, discloses an invention which relates to disposable antiseptic telephone mouthpiece protectors.

### SUMMARY OF THE INVENTION

The present invention concerns that of a new and improved apparatus to cover up a headset of a public phone. The present invention would be fabricated from plastic and would have a small tear-away portion at one end, which would allow the device to be placed over a standard phone. Removal of the tear-away portion would allow a portion of the present invention located over the mouthpiece of the headset to be exposed, but this is likely to be a less offensive part of a public telephone that a user would have to deal with compared to other portions which would be handled more frequently. Once the tear-away portion is removed and the present invention is installed on a standard telephone line, the tear-away portion can be used as a finger cap to dial on the touch tone pad on a telephone associated with the headset of the present invention.

There has thus been outlined, rather broadly, the more important features of a protective phone cover in order that the detailed description thereof that follows may be better understood and in order that the present contribution to the art may be better appreciated. There are, of course, additional features of the protective phone cover that will be described hereinafter and which will form the subject matter of the claims appended hereto.

In this respect, before explaining at least one embodiment of the protective phone cover in detail, it is to be understood that the protective phone cover is not limited in its application to the details of construction and to the arrangements of the components set forth in the following description or illustrated in the drawings. The protective phone cover is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the protective phone cover. It is important, therefore, that the claims be regarded as including such equivalent constructions in so far as they do not depart from the spirit and scope of the present invention.

It is therefore an object of the present invention to provide a protective phone cover which has all of the advantages of the prior art and none of the disadvantages.

It is another object of the present invention to provide a protective phone cover which may be easily and efficiently manufactured and marketed.

It is another object of the present invention to provide a protective phone cover which is of durable and reliable construction.

It is yet another object of the present invention to provide a protective phone cover which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a side view of a headset of the present invention as it would appear when using the present invention.

FIG. 2 shows a front view of a telephone with a touch tone telephone pad and a headset of the present invention as they would appear in use.

### DESCRIPTION OF THE PREFERRED EMBODIMENT

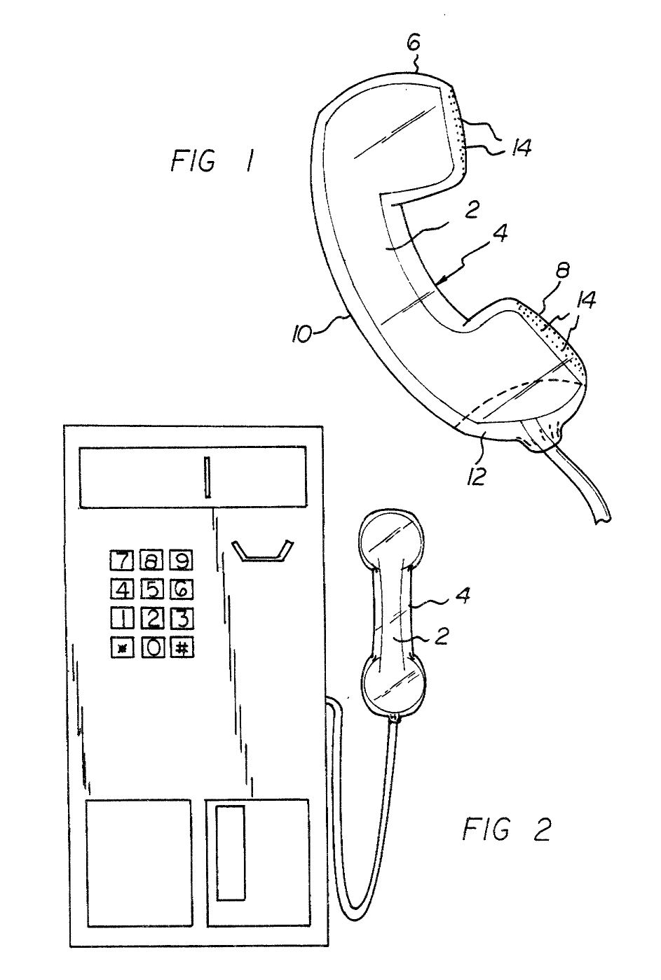

FIG. 1 shows a side view of a headset 2 of the present invention as it would appear when using the protective phone cover 4 that is a part of the present invention. Protective phone cover 4 would have an earpiece portion 6, a mouthpiece portion 8, and a connector 10 between them. Between these three portions of protective phone cover 4, they would substantially cover the entire headset 2 of a standard payphone. Earpiece portion 6 and mouthpiece portion 8 would have a plurality of holes 14 located in the portion of earpiece portion 6 and mouthpiece portion 8 that would be located over the portion of earpiece portion 6 in which a user would place their ear to hear and the portion of mouthpiece portion 8 in which a user would place their mouth to speak.

Mouthpiece portion 8 would also have a tear-away portion 12 located on its end. By removing tear-away portion 12, a user could place protective phone cover 4 over a headset 2 merely by sliding it onto earpiece portion 6 first, and then proceeding to pull protective phone cover 4 down over the entire length of headset 2 until the entire headset 2 is covered. A user could then use tear-away portion 12 as a finger cot in which to place over the finger or fingers that the user would use to dial a number with on the touchtone pad of a telephone. By doing this, a user would not need to actually physically touch any portion of a public telephone, except when installing protective phone cover 4 onto a headset 2.

FIG. 2 shows a front view of a telephone with a touch tone telephone pad and a headset 2 of the present invention as they would appear in use. In order to properly use protective phone cover 2, it would ideally be fabricated from a flexible material.

What I claim as my invention is:

1. A protective phone cover comprising:
(a) an ear piece portion, the ear piece portion including a front face,
(b) a mouth piece portion, the mouth piece portion including a front face,
(c) a connector having two ends, a first end and a second end, the first end connected to the ear piece portion, the second end connected to the mouth piece portion, and
(d) a plurality of holes located on the front face of the ear piece portion and the front face of the mouth piece portion.

2. A protective phone cover according to claim 1 wherein the protective phone cover further comprises a tear-away portion, the tear-away portion removably attached to the mouth piece portion, wherein removal of the tear-away portion will allow placement of the protective phone cover over a telephone, and further wherein the tear-away portion could be used as a finger protector while dialing numbers after the tear-away portion has been removed from the protective phone covering.

3. A protective phone cover according to claim 1 wherein the protective phone cover would be fabricated from a flexible material.
